(19) United States
(12) Patent Application Publication
(10) Pub. No.: US 2011/0180376 A1
(43) Pub. Date: Jul. 28, 2011

(54) SWITCH DEVICE

(75) Inventor: Keiyu Takewaka, Fukui (JP)

(73) Assignee: Panasonic Corporation, Osaka (JP)

(21) Appl. No.: 12/969,717

(22) Filed: Dec. 16, 2010

(30) Foreign Application Priority Data
Jan. 27, 2010 (JP) 2010-014963

(51) Int. Cl. H01H 9/18

(52) U.S. Cl. 200/308

(57) ABSTRACT

A switch device includes an operation body and a switch contact. The operation body includes an operation surface, and a display part formed on the operation surface. The switch contact is brought into or out of conduction according to the movement or rotation of the operation body. The operation body further includes first ribs on both sides of the display part on the operation surface. The first ribs extend in the direction orthogonal to the direction in which the operation body moves or rotates, and are higher in height than the display part.

### BACKGROUND OF THE INVENTION

1. Field of the Invention

The present invention relates to a switch device used to operate various electronic apparatuses, particularly in-vehicle electronic apparatuses.

2. Background Art

In recent years, automobiles have come to be equipped with switch devices of various operating methods, on their steering wheels and front panels, for the user to operate electronic apparatuses such as an air conditioner and an audio system.

One such conventional switch device will be described as follows with reference to FIGS. 5 and 6. FIG. 5 is a sectional view of the conventional switch device, and FIG. 6 is a perspective view of an essential part of the switch device of FIG. 5. The switch device includes case 1 and operation body 2, which are made of an insulating resin. Case 1 has an open bottom, opening 1A in its top surface, and shafts 1B projecting inside. Operation body 2 has, at approximately its center, operating part 2A projecting through opening 1A. Operation body 2 further has shaft holes 2H supported with respect to shafts 1B so as to be movable in the right and left direction of FIG. 5 in case 1.

Operation body 2 further has light-transmitting part 2B and light-non-transmitting part 2C coating the surface of light-transmitting part 2B. Light-transmitting part 2B has a light color such as white or milky white, and light-non-transmitting part 2C has a dark color such as black. Light-non-transmitting part 2C is partially removed by laser to expose light-transmitting part 2B in a predetermined shape such as a graphic or a symbol, thereby forming illumination display parts 2D. Illumination display parts 2D are, for example, in the shape of an inverted triangle as shown in FIG. 6.

Operation body 2 further has flat operation surface 2E on top of operating part 2A, and display part 2F on operation surface 2E. Display part 2F shows, for example, pad-printed letters “TEMP” on light-non-transmitting part 2C as shown in FIG. 6.

The switch device further includes wiring board 3, push switches 4, and light-emitting device 5. Wiring board 3 has wiring patterns (not shown) on its upper and lower surfaces. Push switches 4 are automatic return switch contacts, and are located on the top surface of wiring board 3 and below operation body 2. Light-emitting device 5 is, for example, an LED, and is located at the approximate center of the top surface of wiring board 3.

The switch device further includes pins 6 and holding body 7, which are made of an insulating resin. Holding body 7 has guide holes 7A through which pins 6 are vertically movable. Pins 6 are in contact at their top surfaces with pressing parts 2G projecting from the bottom surface of operation body 2, and are in contact at their bottom surfaces with the top surfaces of push buttons 4A of push switches 4.

The above-described switch device is attached to the spoke (not shown) of the steering wheel of an automobile in such a manner that the top surface of operation body 2 is located on the front side. Push switches 4 and light-emitting device 5 are electrically connected to the electronic circuit (not shown) of the automobile via the wiring patterns, lead wires (not shown), and the like.

It is assumed that the user stretches a thumb to press and move operation surface 2E of operating part 2A in the right or left direction while holding the steering wheel. Then, operation body 2 moves about shaft holes 2H. According to the direction of the movement of operation body 2, pressing parts 2G move pin 6 downward, thereby pressing push buttons 4A. As a result, the contact parts (not shown) of push switches 4 are electrically connected and disconnected with each other.

The electronic circuit detects the electrical connection and disconnection of push switches 4 so as to control the apparatuses mounted on the automobile, thereby, for example, adjusting the temperature of an air conditioner.

At night or in dark environments such as tunnels, illumination display parts 2D are illuminated by light-emitting device 5 although display part 2F of operation surface 2E is not illuminated. This helps the user to operate operating part 2A in the right and left direction.

Thus, attaching the switch device to the steering wheel allows the user to move operation body 2 by only stretching a thumb or a finger, while keeping a hand on the steering wheel. This facilitates the user to control and operate the apparatuses equipped in the automobile especially while driving.

When pressing and moving flat operation surface 2E of operating part 2A with a thumb, the user touches nearly the whole surface of display part 2F of operation surface 2E with the pad of the thumb. The repeated moving of operation surface 2E causes the print on display part 2F to be worn or rubbed off.

### SUMMARY OF THE INVENTION

The switch device of the present invention includes an operation body and a switch contact. The operation body includes an operation surface, and a display part formed on the operation surface. The switch contact is brought into or out of conduction according to the movement or rotation of the operation body. The operation body further includes first ribs on both sides of the display part on the operation surface. The first ribs extend in the direction orthogonal to the direction in which the operation body moves or rotates, and are higher in height than the display part.

### BRIEF DESCRIPTION OF THE DRAWINGS

FIG. 1 is a sectional view of a switch device according to an embodiment of the present invention.

FIG. 2 is a perspective view of an essential part of the switch device shown in FIG. 1.

FIG. 3 is a perspective view of an essential part of another switch device according to the embodiment of the present invention.

FIG. 4 is a perspective view of an essential part of still another switch device according to the embodiment of the present invention.

FIG. 5 is a sectional view of a conventional switch device.

FIG. 6 is a perspective view of an essential part of the switch device of FIG. 5.

### DETAILED DESCRIPTION OF THE INVENTION

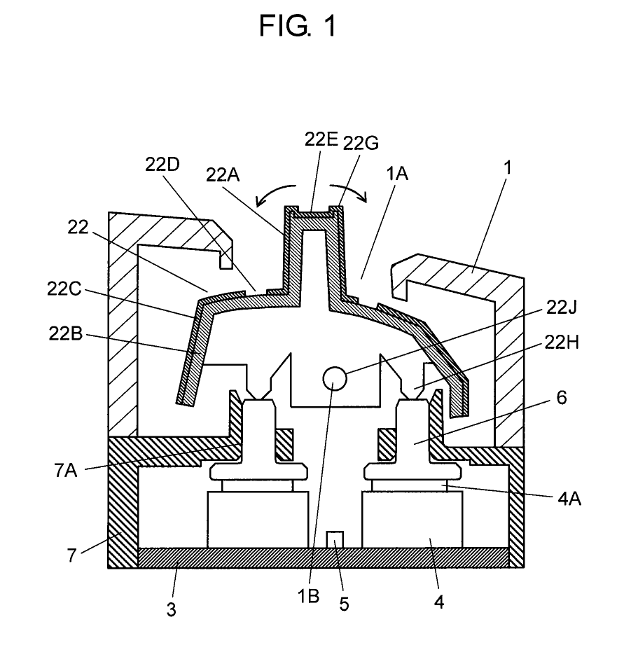

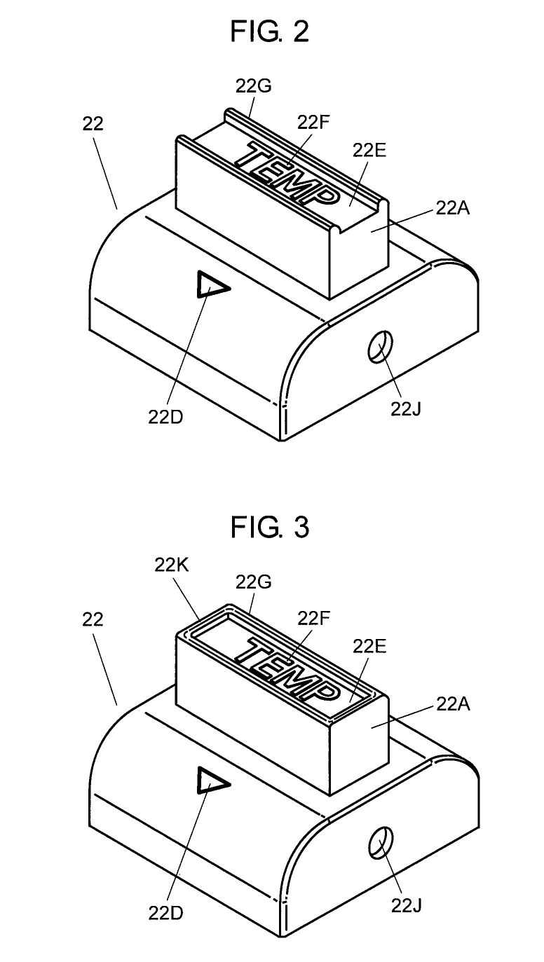

FIG. 1 is a sectional view of a switch device according to an embodiment of the present invention. FIG. 2 is a perspective view of an essential part of the switch device shown in FIG. 1. The switch device includes operation body 22 and push switches 4. Operation body 22 includes operation surface 22E, and display part 22F on operation surface 22E. Push switches 4 are switch contacts, which are brought into or out of conduction according to the movement or rotation of operation body 22.

The switch device further includes case 1, which is made of an insulating resin such as ABS (acrylonitrile butadiene styrene) resin. Case 1 has an open bottom, opening 1A in its top surface, and shafts 1B projecting inside. Operation body 22 is made of an insulating resin such as polycarbonate or ABS. Operation body 22 has, at approximately its center, operating part 22A projecting upward through opening 1A. Operation body 22 further has shaft holes 22J supported with respect to shafts 1B so as to be movable in the right and left direction of FIG. 1 in case 1.

Operation body 22 further has light-transmitting part 22B and light-non-transmitting part 22C coating the surface of light-transmitting part 22B. Light-transmitting part 22B has a light color such as white or milky white, and light-non-transmitting part 22C has a dark color such as black. Light-non-transmitting part 22C is partially removed by laser to expose light-transmitting part 22B in a predetermined shape such as a graphic or a symbol, thereby forming illumination display parts 22D near the bottom of both sides operation part 22A. Illumination display parts 22D are, for example, in the shape of an inverted triangle as shown in FIG. 2.

The switch device further includes wiring board 3, push switches 4, and light-emitting device 5. Wiring board 3 has wiring patterns (not shown) on its upper and lower surfaces. Push switches 4 are automatic return switch contacts, and are located on the top surface of wiring board 3 and below operation body 22. Light-emitting device 5 is, for example, an LED, and is located at the approximate center of the top surface of wiring board 3.

Display part 22F shows, for example, pad-printed letters “TEMP” on light-non-transmitting part 22C of operation surface 22E on top of operating part 22A as shown in FIG. 2. Operation body 22 further includes ribs 22G (first ribs), which extend on both sides of display part 22F in FIG. 2 and in the direction orthogonal to the direction in which operating part 22A moves.

Ribs 22G have a length equal to or longer than the longitudinal length of display part 22F (in the direction orthogonal to the direction in which operation body 22 moves). Ribs 22G project in the range of 0.4 mm to 2.0 mm from operation surface 22E. This is because when ribs 22G are lower than 0.4 mm in height, the print on display part 22F tends to be worn or rubbed off, whereas when ribs 22G are higher than 2.0 mm, it is hard for the user to operate operating part 22A.

Therefore, i n the case of providing ribs 22G, when the user presses operation surface 22E of operating part 22A with a thumb to move operation body 22, the pad of the thumb comes into immediate contact with ribs 22G rather than with display part 22F.

The switch device further includes pins 6 and holding body 7, which are made of an insulating resin. Holding body 7 has guide holes 7A through which pins 6 are vertically movable. Pins 6 are in contact at their top surfaces with pressing parts 22H projecting from the bottom surface of operation body 22, and are in contact at their bottom surfaces with the top surfaces of push buttons 4A of push switches 4.

The above-described switch device is attached to the spoke (not shown) of the steering wheel of an automobile in such a manner that the top surface of operation body 22 is located on the front side. Push switches 4 and light-emitting device 5 are electrically connected to the electronic circuit (not shown) of the automobile via the wiring patterns, the lead wires (not shown), and the like.

It is assumed that the user stretches a thumb to press operation surface 22E of operating part 22A so as to move operation body 22 in the right and left direction of FIG. 1 while holding the steering wheel. Then, operation body 22 moves about shaft holes 22J. According to the direction of the movement of operation body 22, pressing parts 22H move pins 6 downward, thereby pressing push buttons 4A. As a result, the contact parts (not shown) of one of push switches 4 are electrically connected and disconnected with each other.

At this moment, when the user presses operation surface 22E with a thumb so as to move operation body 22, the pad of the thumb comes into immediate contact with ribs 22G formed on both sides of display part 22F rather than with display part 22F.

Thus, display part 22F is prevented from being touched with a thumb, and therefore, the print on display part 22F is prevented from being worn or rubbed off and can be kept clear during the repeated movement of operation body 22.

The electronic circuit (not shown) detects the electrical connection and disconnection of push switches 4 so as to control the apparatuses mounted on the automobile, thereby, for example, adjusting the temperature of an air conditioner.

At night or in dark environments such as tunnels, illumination display parts 22D are illuminated by light-emitting device 5 although display part 22F of operation surface 22E is not illuminated. This helps the user to operate operating part 22A in the right and left direction.

Thus, attaching the above-structured switch device to the steering wheel allows the user to move and operate operation body 22 by only stretching a thumb or a finger, while keeping a hand on the steering wheel. This facilitates the user to control and operate the apparatuses equipped in the automobile especially while driving.

Thus, according to the present embodiment, ribs 22G are formed to be higher in height than display part 22F and to extend on both sides thereof on operation surface 22E of operation body 22 and in the direction orthogonal to the direction in which operating part 22A move. Thus, when the user moves operation body 22 with a thumb, the thumb comes into immediate contact with ribs 22G on operation surface 22E rather than with display part 22F. Consequently, in the switch device, display part 22F is prevented from being touched too much, and therefore, the print on display part 22F is prevented from being worn or rubbed off and can be kept clear during the repeated movement of operation body 22.

In the above description, the switch device includes ribs 22G extending on both sides of display part 22F and in the direction orthogonal to the direction in which operating part 22A moves. As shown in FIG. 3, however the present invention can be implemented by additionally providing second ribs 22K in the direction in which operation body 22 moves or rotates. The second ribs 22K connect both ends of the first ribs 22G so as to surround display part 22F like a frame. In other words, ribs 22G and 22K can be arranged around or on the periphery of display part 22F. Such structures can prevent the edges of ribs 22G from being chipped. Ribs 22K preferably project in the range of 0.4 mm to 2.0 mm from operation surface 22E, and are more preferably as high as ribs 22G so as to facilitate their production.

Illumination display parts 22D in the above description are formed into a predetermined shape by removing light-non-transmitting part 22C printed on the top surface of light-transmitting part 22B. Alternatively, illumination display parts 22D may be formed by what is called two-color molding. In the two-color molding, the light-transmitting part and the light-non-transmitting part are molded integrally.

Operation body 22 in the above description is movably supported with respect to case 1, but may alternatively be movably supported with respect to a shaft of holding body 7.

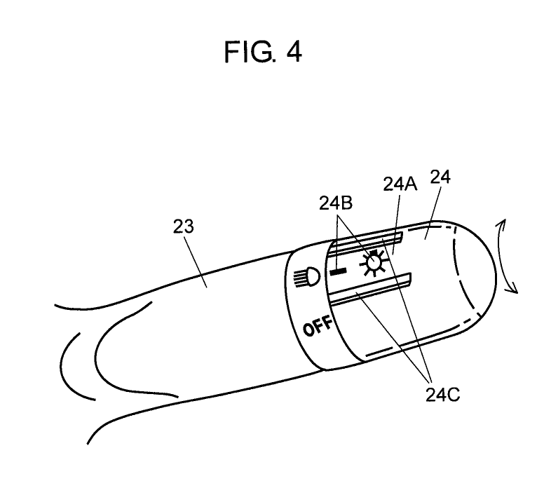

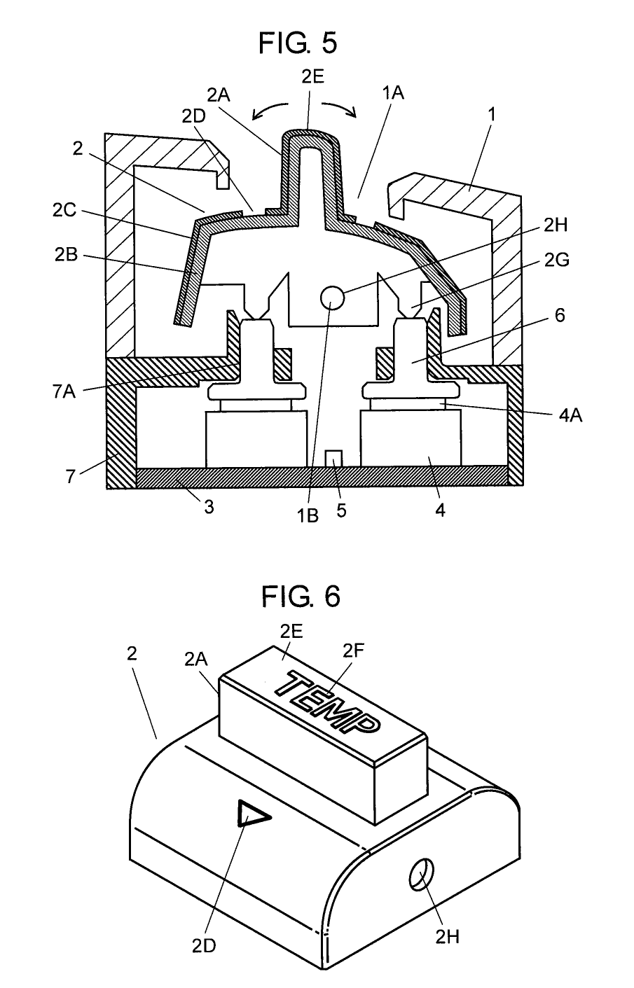

The above-described switch device is of seesaw type in which the switch contacts are brought into or out of conduction by moving operation body 22, but may alternatively be of rotary type as shown in FIG. 4. The rotary switch device includes cylindrical body 23 having switch contact parts (not shown) inside, and cylindrical operation body 24 rotatably held by body 23. The switch contact parts are brought into or out of conduction according to the rotation of operation body 24. Operation body 24 includes operation surface 24A, and display part 24B printed thereon. The present invention can also be implemented by providing ribs 24C on both sides of display part 24B so as to extend in the direction orthogonal to the direction in which operation body 24 rotates.

In the case of thus providing ribs 24C on both sides of display part 24B, the user can rotate operation body 24 with a thumb on ribs 24C. Ribs 24C prevent the thumb from coming into contact with display part 24B, so that the print on display part 24B can be prevented from being worn or rubbed off, thereby being kept clear.

The switch contacts in the above description are formed by mounting automatic return push switches 4 on the top surface of wiring board 3. The switch contacts in the present invention can alternatively be formed by mounting fixed contacts made, for example, of carbon on the top surface of wiring board 3, and by mounting dome-shaped movable contacts made, for example, of conductive sheet metal on the fixed contacts. The switch contacts can further alternatively be formed of fixed contacts, and push buttons arranged above the fixed contacts so as to face each other. The push buttons are made, for example, of rubber and have movable contacts on their bottom surfaces.

As described hereinbefore, the switch device of the present invention has a simple structure to prevent the print on the display part of the operation surface from being worn or rubbed off. A s a result, the print on the display part can be kept clear during the repeated movement or rotation of the operation body. Thus, the switch device is useful to operate various electronic apparatuses, particularly in-vehicle electronic apparatuses.

What is claimed is:

1. A switch device comprising:
an operation body including:
an operation surface; and
a display part formed on the operation surface; and
a switch contact for being brought into or out of conduction according to movement or rotation of the operation body, wherein
the operation body further includes first ribs on both sides of the display part on the operation surface, the first ribs extending in a direction orthogonal to a direction in which the operation body moves or rotates, and being higher in height than the display part.

2. The switch device of claim 1, wherein
the first ribs project in a range of 0.4 mm to 2.0 mm from the operation surface.

3. The switch device of claim 1, wherein
the first ribs have a length not shorter than a length of the display part in the direction orthogonal to the direction in which the operation body moves or rotates.

4. The switch device of claim 1, wherein
the operation body further includes second ribs, the second ribs connecting both ends of the first ribs in the direction in which the operation body moves or rotates.

5. The switch device of claim 4, wherein
the second ribs project in a range of 0.4 mm to 2.0 mm from the operation surface.

6. The switch device of claim 4, wherein
the first ribs and the second ribs are of a same height.
